(19) United States
(12) Patent Application Publication
(10) Pub. No.: US 2025/0188285 A1
(43) Pub. Date: Jun. 12, 2025

(54) Reflective Coating Device and Method of Use

(71) Applicant: Rodman Ward, Phoenix, AZ (US)

(72) Inventor: Rodman Ward, Phoenix, AZ (US)

(21) Appl. No.: 18/966,842

(22) Filed: Dec. 3, 2024

Related U.S. Application Data
(60) Provisional application No. 63/606,616, filed on Dec. 6, 2023.

(51) Int. Cl. C09D 5/33; B60C 11/02; B60C 19/00; C09D 5/00; C09D 5/22; C09D 7/62; C09D 7/63; C09D 7/65; C09D 115/02; C09D 123/22; C09D 133/04; C09D 175/04; C09D 183/04

(52) U.S. Cl. CPC C09D 5/004; B60C 19/00; C09D 5/002; C09D 5/22; C09D 7/62; C09D 7/63; C09D 7/65; C09D 115/02; C09D 123/22; C09D 133/04; C09D 175/04; C09D 183/04; B60C 11/02

(57) ABSTRACT

A reflective coating device and method of use is provided. The device is comprised of a visibility-enhancing coating for retread tires, comprising a multi-layered reflective coating that aids in locating tire fragments on roadways. The device features a primer layer that strongly bonds to the tire rubber, followed by a reflective layer containing microglass beads and aluminum-coated prismatic particles within a binding matrix to ensure consistent reflectivity and durability under wear. High-contrast pigments and UV-stable agents improve visibility and prevent color fading, while optional photoluminescent materials provide passive glow in darkness. An optional topcoat layer shields the reflective layer from abrasion, moisture, and UV damage, enhancing the device's durability in harsh environments. A method for applying the device on tire surfaces ensures long-lasting performance, maintaining visibility under various conditions to enhance road safety.

### CROSS-REFERENCE TO RELATED APPLICATION

The present application claims priority to, and the benefit of, U.S. Provisional Application No. 63/606,616, which was filed on Dec. 6, 2023, and is incorporated herein by reference in its entirety.

### FIELD OF THE INVENTION

The present invention relates generally to the field of tires. More specifically, the present invention relates to a multi-layered reflective coating for retread tires, enhancing the visibility of tire fragments on roadways. The device includes a primer layer for strong adhesion, a reflective layer with microglass beads, and optional photoluminescent and protective topcoat layers to maintain durability, visibility, and color stability under harsh conditions. Accordingly, the present disclosure makes specific reference thereto. Nonetheless, it is to be appreciated that aspects of the present invention are also equally applicable to other like applications, devices, and methods of manufacture.

### BACKGROUND

Detached retread tire debris on roadways represents a critical and growing safety hazard for motorists, particularly in regions with high levels of semi-truck traffic. Retreading, the process of adding new treads to worn tire casings, is a common practice in the trucking industry as it extends the life of tires and reduces costs. However, retread tires are prone to detachment, especially when subjected to the heavy loads and high speeds common in commercial trucking. When retread fragments, or “road gators,” separate from the tires, they often end up scattered along highways, posing a severe danger to other drivers. These debris pieces can be extremely difficult to detect in time, especially when driving at highway speeds or during low-visibility conditions such as nighttime or bad weather. The presence of such obstacles often forces drivers into sudden evasive maneuvers, which can lead to loss of control, collisions with other vehicles, and, in the worst cases, severe injuries or fatalities.

The unpredictable detachment of retread fragments means drivers may encounter these obstacles at any point in a journey, heightening the risk of accidents. Visibility issues associated with retread debris are particularly challenging for motorists, as the dark rubber material of the tires blends into the road surface, especially under low-light conditions. At night or during heavy rain, fog, or snow, the visibility of these rubber pieces is further diminished, increasing the likelihood that they will go unnoticed until the last moment. Furthermore, semi-truck retread fragments are often large, and their impact with a vehicle at high speed can cause significant damage, from tire punctures to compromised suspension and steering. With these substantial risks, there is a strong need for an effective solution that can ensure retread fragments are highly visible to oncoming drivers, giving them sufficient time to react and avoid collisions.

Therefore, there exists a long-felt need in the art for the reflective coating device and method of use that enhances the visibility of detached retread tire fragments on roadways. There also exists a long-felt need in the art for the reflective coating device and method of use that provides a reliable reflective coating capable of maintaining visibility under low-light and adverse weather conditions. Moreover, there exists a long-felt need in the art for the reflective coating device and method of use that reduces the likelihood of accidents and injuries caused by drivers inadvertently colliding with unseen retread debris.

The subject matter disclosed and claimed herein, in one embodiment thereof, comprises a reflective coating device and method of use. The device is comprised of a visibility-enhancing coating for retread tires, comprising a multi-layered reflective coating that aids in locating tire fragments on roadways. The device features a primer layer that strongly bonds to the tire rubber, followed by a reflective layer containing microglass beads and aluminum-coated prismatic particles within a binding matrix to ensure consistent reflectivity and durability under wear. High-contrast pigments and UV-stable agents improve visibility and prevent color fading, while optional photoluminescent materials provide a passive glow in darkness. An optional topcoat layer shields the reflective layer from abrasion, moisture, and UV damage, enhancing the device's durability in harsh environments. A method for applying the device on tire surfaces ensures long-lasting performance, maintaining visibility under various conditions to enhance road safety.

In this manner, the reflective coating device and method of use of the present invention accomplishes all the forgoing objectives by incorporating a specially formulated reflective coating applied to the inner side of semi-truck retread tires. This reflective coating is applied prior to tire installation, ensuring that any tire fragments detached from the vehicle are immediately visible to oncoming motorists. By significantly enhancing visibility in low-light conditions, the reflective coating device and method of use minimizes the risk of sudden encounters with road gators, promoting safer driving environments. This solution effectively aids in the early detection of retread debris, helping drivers to take timely action to avoid collisions, thus reducing accidents and enhancing overall road safety.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a reflective coating device and method of use. The device comprises a multi-layered reflective coating applied to the inner surface of retread tires to enhance visibility of tire fragments on roadways, promoting road safety when such fragments are scattered.

The device includes a primer layer designed to adhere strongly to the rubber surface, utilizing chlorinated rubber or butyl-based compounds. The primer layer may also contain adhesion promoters, like organosilanes or maleic anhydride grafted polymers, which enhance compatibility and bonding with the rubber, reducing risks of peeling or delamination under environmental stress.

A reflective layer is applied over the primer layer, containing reflective elements such as microglass beads and aluminum-coated prismatic particles. These elements, made of materials like soda-lime glass and polycarbonate or PMMA, achieve retro-reflectivity, intensifying light directed from vehicle headlights, especially at night.

This reflective layer includes a binding matrix, potentially composed of polyurethane or acrylic resins, to hold reflective elements in place despite wear. The matrix materials are chosen for their flexibility and adhesion to the primer, resisting cracking and ensuring secure embedding of reflective elements even under repeated impacts.

To enhance visibility, the reflective layer may incorporate high-contrast pigments, such as titanium dioxide for white, iron oxide for yellows and reds, and fluorescent pigments for neon shades. These UV-stable pigments are uniformly dispersed to maintain visibility as the tire fragment weathers, with UV-absorbing agents like benzotriazole to prevent fading from sunlight.

The reflective layer may also contain photoluminescent elements like strontium aluminate doped with rare earth elements, providing passive illumination in low-light conditions by emitting a glow after absorbing ambient light. These particles are distributed evenly within the matrix to ensure consistent luminosity.

For added protection, an optional topcoat layer can be applied, shielding the reflective and photoluminescent elements from abrasion, moisture, and chemicals. This topcoat, potentially made of clear polyurethane or silicone with silica nanoparticles for added hardness, provides high resistance to road contaminants. It may also include UV stabilizers like hindered amine light stabilizers (HALS) to prevent degradation from sunlight, preserving the device's reflective and photoluminescent properties over the tire's lifespan.

The invention includes a method for applying the device, where a primer layer is first applied to the tire's inner surface. The reflective layer is then applied over the primer layer, followed by the optional topcoat layer, ensuring the structure's durability and effectiveness.

Accordingly, the reflective coating device and method of use of the present invention is particularly advantageous as it ensures that any tire fragments detached from the vehicle are immediately visible to oncoming motorists. By significantly enhancing visibility in low-light conditions, the reflective coating device and method of use minimizes the risk of sudden encounters with road gators, promoting safer driving environments. This solution effectively aids in the early detection of retread debris, helping drivers to take timely action to avoid collisions, thus reducing accidents and enhancing overall road safety.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of one potential embodiment of a reflective coating device and method of use of the present invention in accordance with the disclosed architecture; and

FIG. 2 illustrates a flowchart of a method of using one potential embodiment of a reflective coating device and method of use of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for the reflective coating device and method of use that enhances the visibility of detached retread tire fragments on roadways. There also exists a long-felt need in the art for the reflective coating device and method of use that provides a reliable reflective coating capable of maintaining visibility under low-light and adverse weather conditions. Moreover, there exists a long-felt need in the art for the reflective coating device and method of use that reduces the likelihood of accidents and injuries caused by drivers inadvertently colliding with unseen retread debris.

The present invention, in one exemplary embodiment, is comprised of a reflective coating device and method of use. The disclosed invention comprises a reflective coating device and method to enhance visibility of tire fragments on roadways, thereby improving road safety. The device consists of a multi-layered reflective coating applied to the inner surface of retread tires.

The device includes a primer layer that adheres strongly to the rubber surface using chlorinated rubber or butyl-based compounds. This primer layer may also incorporate adhesion promoters, such as organosilanes or maleic anhydride grafted polymers, to strengthen bonding with the rubber and reduce the risks of peeling or delamination due to environmental stress.

A reflective layer is applied over the primer layer, containing reflective elements such as microglass beads and aluminum-coated prismatic particles. These elements, made from materials like soda-lime glass and polycarbonate or PMMA, produce retro-reflectivity to enhance visibility by reflecting light from vehicle headlights.

The reflective layer also includes a binding matrix, possibly made from polyurethane or acrylic resins, to hold the reflective elements in place despite surface wear. This matrix is selected for flexibility and adhesion to prevent cracking and ensure the reflective elements remain securely embedded under repeated impacts.

To further enhance visibility, the reflective layer may include high-contrast pigments, such as titanium dioxide for white, iron oxide for yellow and red, and fluorescent pigments for neon shades. These UV-stable pigments are uniformly dispersed within the matrix, with UV-absorbing agents like benzotriazole to resist fading from sunlight.

The reflective layer may also contain photoluminescent elements, such as strontium aluminate doped with rare earth elements, to provide passive illumination in low-light conditions by emitting a glow after absorbing ambient light. These particles are evenly distributed within the matrix to maintain consistent luminosity.

For additional protection, an optional topcoat layer can be applied to shield the reflective and photoluminescent elements from abrasion, moisture, and chemicals. This topcoat, possibly made of clear polyurethane or silicone with silica nanoparticles for added hardness, provides high resistance to road contaminants. It may also include UV stabilizers like hindered amine light stabilizers (HALS) to prevent sunlight degradation, preserving the device's reflective and photoluminescent qualities over the tire's lifespan.

The invention also includes a method for applying the device, where the primer layer is first applied to the inner surface of the tire. The reflective layer is then applied over the primer layer, followed by the optional topcoat layer, ensuring durability and effectiveness.

Accordingly, this reflective coating device and method significantly enhance visibility in low-light conditions, helping oncoming motorists detect tire fragments and avoid sudden encounters with debris, thereby reducing accidents and promoting safer driving environments.

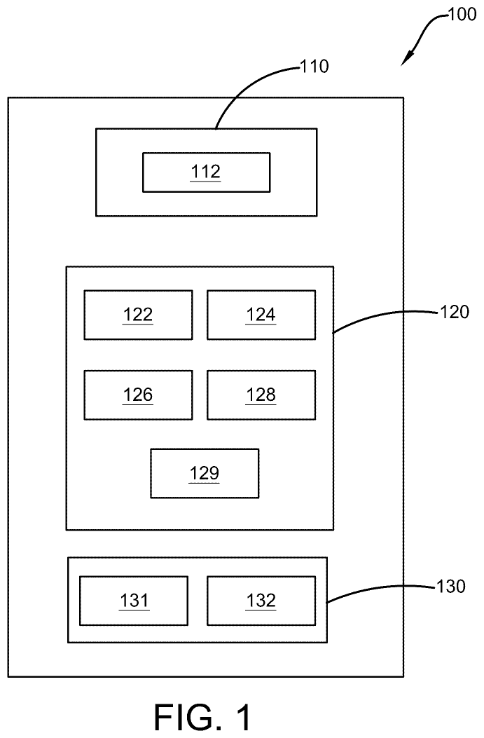

Referring initially to the drawings, FIG. 1 illustrates a graphical view of one potential embodiment of a reflective coating device and method of use 100 of the present invention in accordance with the disclosed architecture. The device 100 is comprised of a multi-layered, specialized reflective coating applied to the inner surface of retread tires. As a result, the device 100 enhances the visibility of tire fragments on roadways, improving road safety when retread tires separate and are left scattered across a roadway.

The device 100 includes a primer layer 110 designed to establish a strong bond with the rubber surface of the retread tire. The primer layer 110 is comprised of chlorinated rubber or butyl-based adhesive compounds that have a high affinity for rubber substrates, creating a durable base. To further improve adhesion, the primer layer 110 may be comprised of adhesion promoters 112 such as organosilanes or maleic anhydride grafted polymers. These promotors 112 increase the compatibility between the rubber of the tire and the primer layer 110, enhancing the molecular bonding at the interface and minimizing the risk of peeling or delamination, even under high stress from environmental factors or impact.

The device 100 further comprises a reflective layer 120 applied over the primer layer 110. This reflective layer 120 is comprised of reflective elements 122 embedded within a robust, weather-resistant matrix. The reflective elements 122 may include microglass beads and aluminum-coated prismatic particles. Microglass beads may be comprised of soda-lime glass with a high refractive index and are preferably spherical to create a uniform distribution of reflectivity by refracting and reflecting light in all directions. Aluminum-coated prismatic particles, which may be made from polycarbonate or polymethyl methacrylate (PMMA) and coated with thin aluminum layers, are designed to achieve a retroreflective effect that intensifies light directed from headlights back towards the source, enhancing nighttime visibility.

The reflective layer 120 also incorporates a binding matrix 126 that holds the reflective elements 122 in place, maintaining their visibility despite surface wear. This matrix 126 may be comprised of polyurethane or acrylic resins that provide flexibility and excellent adhesion to the primer layer 110 while retaining elasticity. These binding matrix 126 materials are selected for their resistance to cracking and deformation, ensuring that the reflective elements 122 remain securely embedded within the reflective layer 120 even under repeated flexing and impacts.

To further enhance visibility, the reflective layer 120 may include high-contrast pigments 128 for color contrast and durability, which may include titanium dioxide (TiO₂) for bright white, iron oxide for shades of yellow or red, and fluorescent pigments for neon yellow or orange. These pigments are UV-stable and may be comprised of UV-absorbing agents 129 like benzotriazole or benzophenone derivatives to prevent fading under prolonged sunlight exposure. The pigments 128 are dispersed uniformly within the matrix 126, ensuring consistent color visibility even as the tire fragment weathers.

The reflective layer 120 may also include photoluminescent elements 124 to provide passive illumination in low-light environments. These elements 124 may include strontium aluminate doped with rare earth elements such as but not limited to europium and dysprosium. These materials have high photoluminescent efficiency, absorbing ambient light or vehicle headlights and re-emitting it as a soft glow in the dark. The strontium aluminate particles are suspended uniformly within the reflective layer 120 matrix, ensuring consistent luminosity across the surface and preventing material settling that could diminish brightness over time.

For added durability and environmental protection, an optional topcoat layer 130 may be applied over the reflective layer 120. This topcoat layer 130 is designed to shield the reflective elements 122 and photoluminescent elements 124 from abrasion, moisture, and chemical exposure. The topcoat 130 may be comprised of a clear polyurethane or silicone-based coating 131 with high resistance to road contaminants such as oils, salt, and other chemicals encountered on roadways. To enhance abrasion resistance, the topcoat 130 may also be comprised of silica nanoparticles, which increase the hardness of the topcoat without sacrificing transparency or flexibility.

In addition, the topcoat layer 130 may be comprised of hindered amine light stabilizers 132 (HALS), which are UV stabilizers that prevent degradation from prolonged sunlight exposure. As a result, this prevents oxidation and breakdown of the reflective layer 120, ensuring the reflective and photoluminescent qualities of the device 100 remain effective over the extended life of the tire.

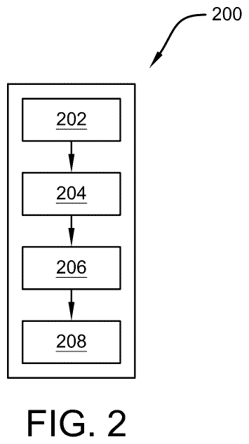

The present invention is also comprised of a method of using 200 the device 100, as seen in FIG. 2. First, a device 100 is provided comprised of a primer layer 110, a reflective layer 120 that may be comprised of a reflective element 122, a photoluminescent element 124, a pigment 128, a UV-absorbing agent 129, and a binding matrix 126, and a topcoat layer 130 comprised of a coating 131 and a stabilizer 132 [Step 202]. Then, the primer layer 110 can be applied to a surface of a tire, preferably on an inner surface of the tire that contacts a wheel rim [Step 204]. Next, the reflective layer 120 can be applied over the primer layer 110 [Step 206]. Finally, the topcoat layer 130 can be applied over the reflective layer 120 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “reflective coating device and method of use” and “device” are interchangeable and refer to the reflective coating device and method of use 100 of the present invention.

Notwithstanding the forgoing, the reflective coating device and method of use 100 of the present invention and its various components can be of any suitable size and configuration as is known in the art without affecting the overall concept of the invention, provided that they accomplish the above-stated objectives. One of ordinary skill in the art will appreciate that the size, configuration, and material of the reflective coating device and method of use 100 as shown in the FIGS. are for illustrative purposes only, and that many other sizes and shapes of the reflective coating device and method of use 100 are well within the scope of the present disclosure. Although the dimensions of the reflective coating device and method of use 100 are important design parameters for user convenience, the reflective coating device and method of use 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A reflective coating device comprising:
a primer layer comprising a chlorinated rubber or butyl-based adhesive compound;
a reflective layer positioned over the primer layer, the reflective layer comprising a reflective element embedded within a binding matrix; and
a topcoat layer applied over the reflective layer, the topcoat layer comprising a clear coating.

2. The reflective coating device of claim 1, wherein the reflective element is comprised of a microglass bead.

3. The reflective coating device of claim 1, wherein the reflective element is comprised of an aluminum-coated prismatic particle.

4. The reflective coating device of claim 1, wherein the primer layer is comprised of an adhesion promoter.

5. The reflective coating device of claim 4, wherein the adhesion promoter is comprised of an organosilane or a maleic anhydride grafted polymer.

6. The reflective coating device of claim 2, wherein the microglass bead is comprised of a spherical shape.

7. The reflective coating device of claim 2, wherein the microglass bead is comprised of a soda-lime glass.

8. The reflective coating device of claim 1, wherein the binding matrix is comprised of a polyurethane or an acrylic resin.

9. The reflective coating device of claim 1, wherein the reflective layer is comprised of a high-contrast pigment.

10. The reflective coating device of claim 9, wherein the high contrast pigment is comprised of a titanium dioxide, an iron oxide, or a fluorescent pigment.

11. The reflective coating device of claim 1, wherein the topcoat layer is comprised of a stabilizer.

12. The reflective coating device of claim 11, wherein the stabilizer is comprised of a hindered amine light stabilizer.

13. A reflective coating device comprising:
a primer layer comprising a chlorinated rubber or butyl-based adhesive compound, wherein the primer layer is configured to bond with the rubber surface of a retread tire;
a reflective layer positioned over the primer layer, the reflective layer comprising a reflective element embedded within a binding matrix and a photoluminescent element; and
a topcoat layer applied over the reflective layer, the topcoat layer comprising a clear coating.

14. The reflective coating device of claim 13, wherein the reflective layer is comprised of a benzotriazole or a benzophenone derivative.

15. The reflective coating device of claim 13, wherein the photoluminescent element is comprised of a strontium aluminate doped with a rare earth elements.

16. The reflective coating device of claim 15, wherein the rare earth element is comprised of a europium or a dysprosium.

17. The reflective coating device of claim 13, wherein the binding matrix is comprised of a polyurethane or an acrylic resin.

18. The reflective coating device of claim 13, wherein the topcoat layer is comprised of a silicone.

19. The reflective coating device of claim 13 further comprised of a high-contrast pigment that is uniformly distributed throughout the binding matrix.

20. A method of using a reflective coating device and method of use, the method comprising:
providing a reflective coating device and method of use comprised of a primer layer, a reflective layer, and a topcoat layer;
applying the primer layer to an inner surface of the retread tire;
applying the reflective layer over the primer layer; and
applying the topcoat layer over the reflective layer.
